(19) United States
(12) Patent Application Publication
(10) Pub. No.: US 2018/0280849 A1
(43) Pub. Date: Oct. 4, 2018

(54) AEROSTAT LIQUID AEROSOL COLLECTOR (ALAC)

(71) Applicant: MANSUR ABAHUSAYN, Mission Viejo, CA (US)

(72) Inventor: MANSUR ABAHUSAYN, Mission Viejo, CA (US)

(21) Appl. No.: 15/476,008

(22) Filed: Mar. 31, 2017

(51) Int. Cl. B01D 45/08; B64B 1/50

(52) U.S. Cl. CPC B01D 45/08; B64B 1/50

(57) ABSTRACT

A tethered aerostat is provided to cause turbulence and coalescence of liquid micro-droplets in the atmosphere to form larger drops that adhere to aerostat solid surface for collection and delivery to designated location for drinking and other uses. Apparatus may also produce renewable energy from wind turbines at higher elevations where the wind speed is higher than conventional wind turbines.

### BACKGROUND

### Field of the Invention

The present invention is directed to an apparatus and methods of a liquid aerosol collector to produce water and renewable energy from the atmosphere.

### Detailed Description of the Invention

The current state of the art for conversion of suspended atmospheric liquid micro-droplets, such as water in fog or clouds, to large drops that could fall as rain is through either cloud seeding, which is very expensive, unspecified target for product, has not been found credible, or fog nets which are very inefficient, expensive, occupy large footprint and produce meager amount of water which limited their wide spread and commercial use.

Water scarcity is best reflected in the May 3, 2016 World Bank report regarding world water that summed up the dire water situation worldwide by stating: “Water scarcity, exacerbated by climate change, could cost some regions up to 6 percent of their GDP, spur migration, and spark conflict. The combined effects of growing populations, rising incomes, and expanding cities will see demand for water rising exponentially, while supply becomes more erratic and uncertain. Unless action is taken soon, water will become scarce in regions where it is currently abundant—such as Central Africa and East Asia—and scarcity will greatly worsen in regions where water is already in short supply—such as the Middle East and the Sahel in Africa. These regions could see their growth rates decline by as much as 6 percent of GDP by 2050 due to water related impacts on agriculture, health, and incomes”.

“Reduced freshwater availability and competition from other uses—such as energy and agriculture—could reduce water availability in cities by as much as two thirds by 2050, compared to 2015 levels. Water insecurity could multiply the risk of conflict, the report adds. Food price spikes caused by droughts can inflame latent conflicts and drive migration. Where economic growth is impacted by rainfall, episodes of droughts and floods have generated waves of migration and spikes in violence within countries”.

Fog has been recognized as a significant source of ample clean water if it could be harvested in large quantities and economically. The need for clean good quality water is compelling. Fog and clouds represent a potential source of sustainable good quality water. Two technologies are currently used to extract water from clouds and fog Cloud seeding, where clouds are nucleated and induced to rain uncontrollably, is a commercial large scale technology but has not demonstrated convincing reproducible results.

Fog nets have been successfully used to extract water from fog. They are permeable plastic mesh erected facing the prevailing fog direction on fixed ground poles in carefully selected fog rich locations. Fog collectors are used in an number of selected world sites to extract water.

The average cost of a ground anchored one square meter fog net is 150 US Dollars. At an interest rate at 5%, depreciation at 10%, and operation and maintenance done by volunteers (free), the cost per cubic meter of water for a 10-liter per square meter daily production of 100 foggy days per year is about 22 US Dollars. Water from fog study in Saudi Arabia Aseer mountains that included operation and maintenance by hired workers, resulted in a cost of 37 US Dollars per cubic meter. Fog harvesting technology has not found wide spread commercial use. The draw backs of fog nets are: 1) high cost per cubic meter of water produced, 2) meager production of only 6% water extraction efficiency, 3) extensive ground footprint, 4) vandalism, 5) limited upscaling and commerciality, 6) unfavorable close to ground location where fog water content and wind speed are most unfavorable for fog water extraction, 7) contamination of the water by birds and flying insects.

Fog and cloud water, even though present in very small droplets and quantity in the atmosphere, represent a phase change from vapor to liquid, a significant energy saving. Even though the absolute quantity of water held in fog and clouds at a point in time is small, it is essentially large as it constitutes a phase in the hydrological cycle where it is continuously being replenished.

The challenge to commercial large scale and economic extraction of water from fog and clouds is to employ processes and devise apparatus that could capture fog and cloud water at much higher efficiency, reduced ground footprint, in commercial quantities, economically, environmentally friendly, and energy and carbon neutral to supply commercial quantities of good quality water to meet demand on one hand and supply storage to even out supply during periods of no fog or clouds. The present invention addresses this challenge and produce commercial quantities of water economically.

Devising effective processes and apparatus to collect water from fog and clouds requires the understanding of the scientific findings of the extensive research which has been conducted over the years and devise the apparatus to employ this wealth of research that has not so far been converted to viable commercial applications. Some research based information and data that may provide a better understanding of warm cloud conversion of water micro-droplets droplet to rain drops is based on the turbulence and coalescence theory where micro-droplets of few microns in size grow to water drops of millimeter size to fall as rain and may reach the ground if they do not evaporate during their fall.

Fog net patents are presented below. They present different forms of orientation in the landscape but share the common feature of relying on a permeable net either extended between poles on the ground or hanging from aerostat. An extensive analysis is critically presented in U.S. Pat. No. 9,009,977, U.S. Pat. No. 9,352,258.

Many patents were issued for designs, apparatus and methods of land anchored or airplane supported permeable mesh or nets, centrifugal force or electric charge fog water extraction systems (U.S. Pat. No. 8,221,514, U.S. Pat. No. 8,721,755, U.S. Pat. No. 3,889,532, U.S. Pat. No. 4,475,927, U.S. Pat. No. 9,009,977, U.S. Pat. No. 9,352,258 PT 102351, CN 101000289, CN 201326191, CN 101769831, CN 102175488, CN 201993251). The widespread application has been limited to the permeable mesh which produced meager amount of water from fog. Limited quantities of water were produced and the operation relied on free labor from the community it serves. Since it does not supply enough water to be stored for periods of no fog it failed. One major drawback is the extensive footprint it requires as a ground based application.

U.S. Pat. No. 9,352,258 included an extensive analysis of the traditional mesh fog water collection with the aim of improving its performance through a more precise mesh material, shape, string diameter size, spacing of the mesh opening in relation to the mesh string diameter and surface treatment of the mesh material. It concluded that there is a preferred ratio of mesh string diameter to the opening spacing ratio out of which efficiency drops. Improvements in the water production efficiency resulted in an increase of the efficiency from about 6% to 12%. A 6% efficiency leaves much room for improvement. Mesh fog water extraction is the only practice now used from other patented attempts to extract water from fog or clouds passively other than cloud seeding. Cloud seeding has not been shown to conclusively produce rain, and where it does, the location where rain is supposed to fall is unidentified. Its application is in the realm of rain enhancement and weather modification and not in the extraction process. Cloud seeding attempts to grow the water micro-droplet to a size that will fall to the ground, somewhere, as rain by gravity under its own weight.

The present invention relies on the use of extensive impermeable material constructed and deployed to increase air-liquid aerosol turbulence, induce liquid water coalescence, and provide an impermeable surface to collect coalesced water micro-droplets and convey them to storage. The structure of the present invention is located upright in the atmosphere to reduce foot print and locate the impermeable inflated surfaces high up where wind speed and liquid water content of clouds are higher.

### SUMMARY

In one embodiment of the present invention, tethered aerostat is provided to cause turbulence and coalescence of liquid micro-droplets in the atmosphere to form larger drops that adhere to aerostat solid surface for collection and delivery to designated location for drinking and other uses. Apparatus may also produce renewable energy from wind turbines at higher elevations where the wind speed is higher than conventional wind turbines.

### BRIEF DESCRIPTION OF THE DRAWINGS

FIG. 1. Illustration of Aerosol Extraction Aerostat and Wind Turbine showing major components: upper aerostat, cable, tube array for liquid extraction, funnel, piping, storage, tethers, mooring net, wind turbine, and safety devices.

FIG. 2. Illustration of Aerostat Turbulence and Coalescence Zone that shows the zone of turbulence due to obstruction of flowing gas carrying aerosol by aerostat bubble surface which produces collision and coalescence of liquid micro-droplets to form big drops that adhere to the surface and drain down for collection.

FIG. 3. A Schematic of Aerostat Liquid Collection and Transport Channel that shows channel that collects liquid draining from lower aerostat tube array surfaces and transport conduits to empty liquid into upper main liquid transport conduit along with cross sections of electric cable and main tether.

FIG. 4. Detailed Schematic of Upper Aerostat and Wind Turbine that shows the basic components of wind turbine, upper aerostat liquid collection funnel, and lower aerostat tube array anchor manifold.

### DETAILED DESCRIPTION OF THE PREFERRED EMBODIMENT

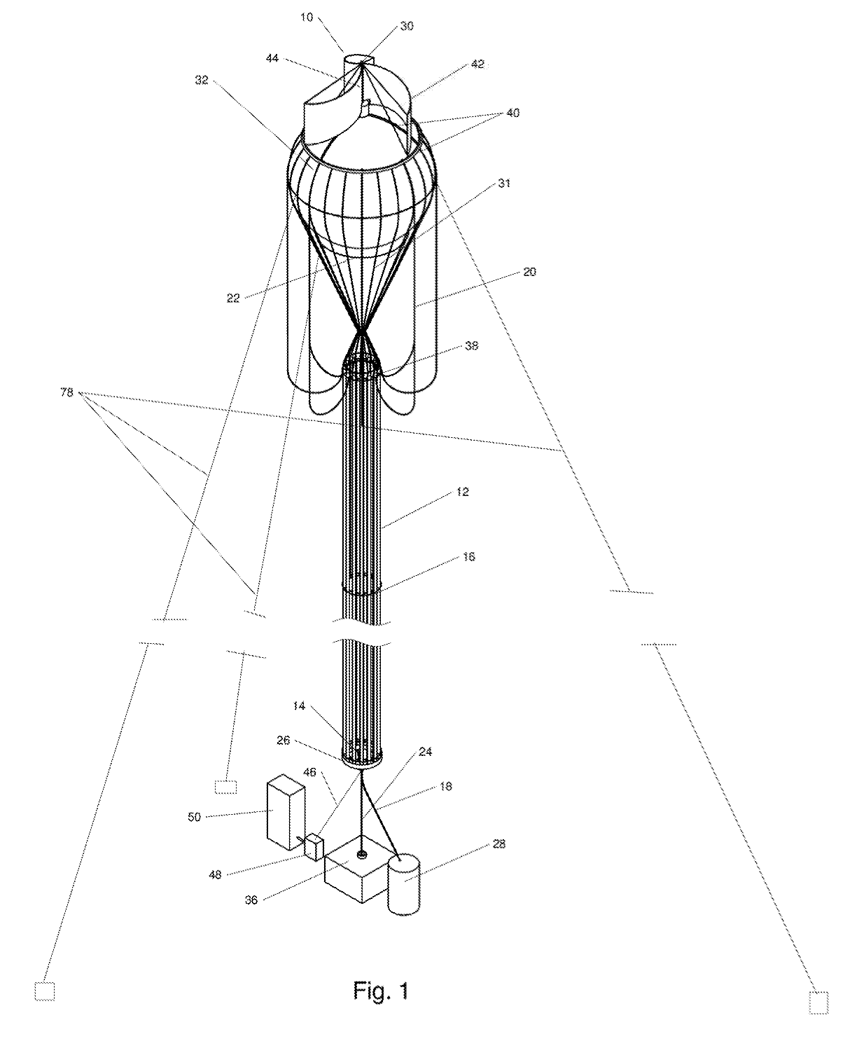

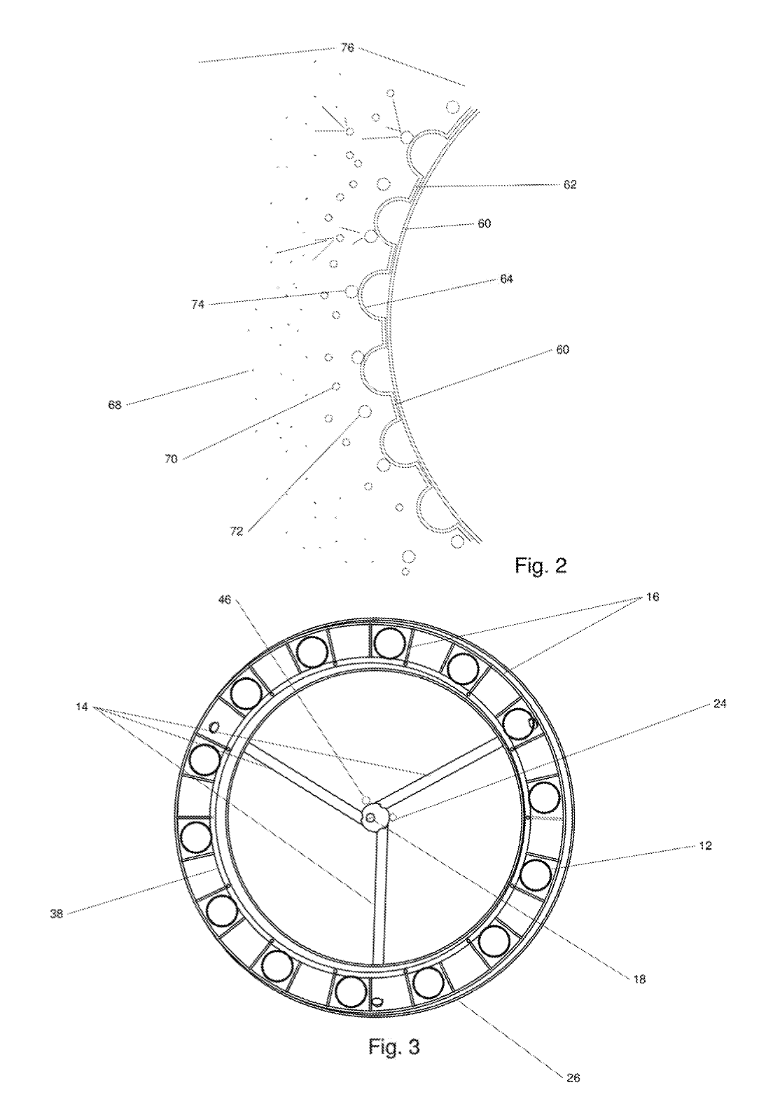

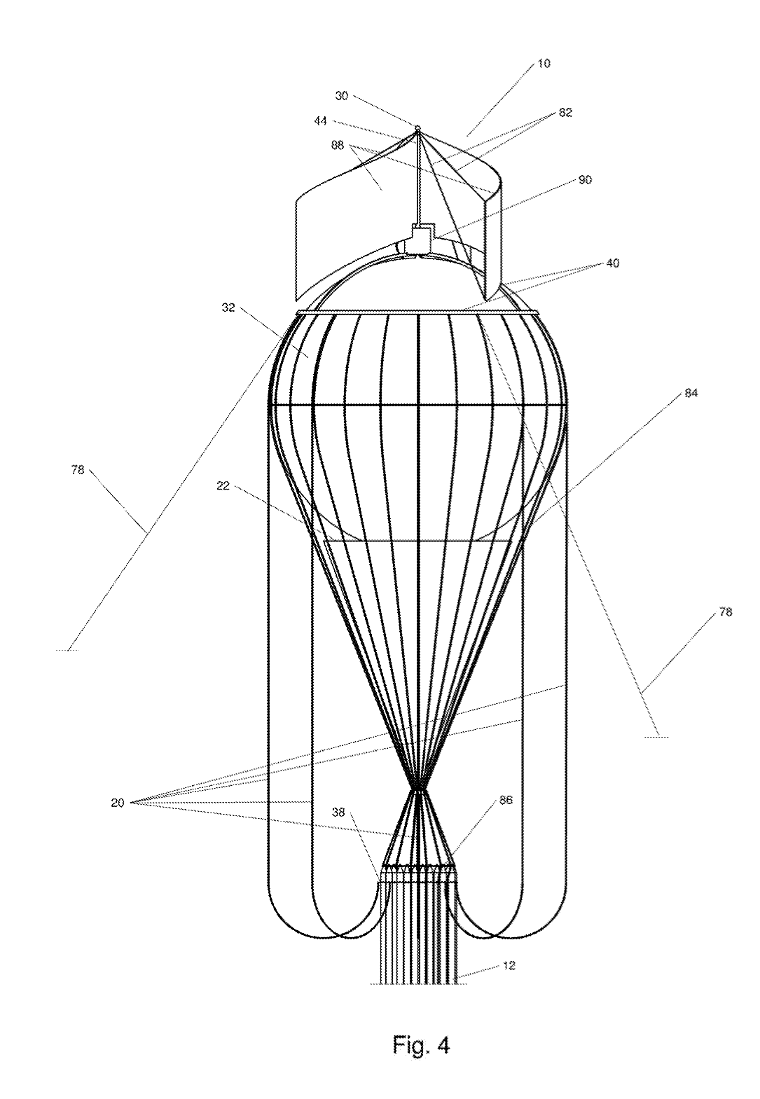

In one embodiment of the present invention to produce water and renewable energy, an aerostat apparatus (FIG. 1) and method to extract aerosol, such as liquid micro-droplets of water in fog and clouds, from a gaseous stream, such as air, is presented. FIG. 1 illustrates the components of the apparatus: upper aerostat 32, which may be in the form of balloon(s), wind turbine(s) 10, upper aerostat restraining net 34, of an apparatus that include at least one aerostat 32 placed to intercept the pathway of aerosol carrying gas to cause separation of heavier aerosol from lighter gas and the coalescence of aerosol into larger drops 76 because of speed reduction when the path of gas flow is interrupted by the surface 60 of the upper aerostat 32 and lower aerostat tube array 12. The impact of the moving gas carrying aerosol micro-droplets on the surface of the aerostats 12 and 32 produces turbulence which in turn results in the coalescence of the aerosol micro-droplets 68 into large drops 72 that slam the surface of the aerostat 12 and 32, slide down the surface into liquid collection funnel 22. The outer surface of the aerostat 12 and 32 may be covered with a film of bubbles 60 to increase turbulence and lead to the liquid aerosol micro-droplets to coalesce to the larger liquid drops 72. The bubbles also increase the surface area of the turbulence and coalescence zones 76 which increases the efficiency of producing more liquid. the aerostat surface bubbles 64 may be coated with alternating hydrophilic and hydrophobic pigments so that the bubble 64 tops are hydrophilic to attract liquid to the surface and increase liquid collection. The skin bubble depressions 66, which occupy the area between the bubbles 64 base surroundings and form channels to drain collected liquid aerosol may be coated with hydrophobic pigment, or made from hydrophobic materials to enhance liquid drop spherical integrity and it's ease to roll down the aerostat surface to storage reservoir 28 through main liquid transport conduit 18.

The aerostat may be restrained in position in the atmosphere by restraint net 16, main tether 24 and side tethers 78. The aerostat may be composed of two or more components, an upper component which may, in one embodiment, resemble one or more tethered balloon and a lower section which is composed of at least one inflated lower aerostat tube or tube array 12, supported at its top by lower aerostat tube array anchor manifold, 38. The manifold 38 may be a ring made of light but strong material, to which the each of the tubes upper ends are attached. The main functions of the upper balloons are to provide buoyancy, payload, rise to the level where aerosol density and wind speed are high, provide the surface to extract liquid aerosol from gas, and support wind turbines 10, lower aerostat tube array and associated lower aerosol liquid collection channel 26. To achieve the required buoyancy goals, the gas filling the balloons and the tube array is preferably lighter than air. The size of the balloons depends on payloads required and the meteorological conditions and orography of the landscape.

In one embodiment, the aerostat upper section diameter ranges from 1-100 meters. The payload limit is affected by drag forces acting on the aerostat and, in one embodiment of the present patent, payload could be 100 to 10,000 kilograms. The aerostat may rise in a preferred embodiment to 600 meters above the ground, the limit set by the FAA so far, where wind speed is many times that at ground level, but the aerostat could rise to 5000 meters, if permitted by law as in the shadow of mountains, or as low as 10 meters, measuring from the lowest point of the apparatus lower component, lower aerostat tube array 12. The location of the aerostat liquid aerosol could be on land, sea, and other locations that are conducive to achieving the objectives of collecting liquid aerosol and generating wind energy.

The lower aerostat tube array 12 is the lower component of the aerostat. Each of the tube may be made of strong but very light material and, in a preferred embodiment, 30 centimeters wide in diameter and one hundred and fifty meters long. The tubes may extend from 10 meters to thousands of meters long, but are currently restricted to about 600-meter vertical height as stipulated by the FAA. They are made of very light and strong material that may be inflated and provide a substrate surface to obstruct the flow of the aerosol carrying gas, initiate turbulence, create a zone of coalescence where micro-droplets of aerosol that would normally float and pass by to instead aggregate into larger drops that adhere to the surface of the tubes and are collected for use. The tubes 12 may be arranged vertically in a cylindrical pattern such that each two tubes are separated by a 5 to 50 cm space to allow the traveling ambient gas impacting the tube surface to pass through after a substantial part of its liquid aerosols have coalesced and adhered to the tube surface as liquid drops.

The cylindrical arrangement of the tube array also helps create a chimney effect so that ambient air loaded with aerosol is channeled into the cavity of the cylinder and provide the internal surfaces of the tube array with aerosols that could be coalesced and deposited on the array surfaces as liquid drops. The tube arrays are maintained in a semi-cylindrical arrangement in space by upper aerostat restraint net 34. Net 34 forms a lattice that runs the length of the lower aerosol tube array 12 and contains each alternate tube within the net. The cylindrical arrangement of the tube array 12 allows for aerosol coalescence into larger drops and collection on the aerostat surface tube array surfaces irrespective of the direction from which the aerosol carrying gas blows. and its aerosols is blowing from. The lower aerostat tubes 12 that restrained from each other within the net 16 are separated by a void between alternate tubes to allow for easy passage of gas around the tube cylindrical surface while the aerosols carried by the gas are coalesced into larger drops that adhere to the tube surface and drain downward for collection. The net 16 is made of very thin and light twine or the like. The net 16 and its contained lower aerosol tube array 12 are maintained in a semi-cylindrical configuration attached to horizontally placed rings that constitute part of the lower aerostat tube array constraint net. The rings may be made of very light and strong material to which the inner sides of the net are tied. The tubes of the lower aerostat tube array 12 and bubbles of their surfaces, in one preferred embodiment, are filled with gas that is lighter than air.

The upper aerostat surface 60 as well as lower aerostat surfaces of tube array 12 may be made of bubbles 60 or wrapped with bubbly material that is light and strong such that the bubbles are filled will with gas to increase surface area and enhance turbulence to increase coalescence of aerosol micro-droplets into drops that are collected by the aerostat surface and slide down for collection in reservoir 28. The aerostat and the bubbles may be filled with gas that is preferably lighter than air. The bubbles of the lower aerostat tube array 12 surfaces, as well as those of the upper aerostat(s), the balloon(s) 60 may, in a preferred embodiment, be 0.25 to 5 cm in diameter. The interspaces between the bubbles 60 may also be 0.25 to 5 cm to allow easy drainage of liquid drops 72 down to storage. Lower aerostat tube diameter, in a preferred embodiment, may range from 5 to 50 cm. The upper end of lower aerostat tubes 12 are attached to tube array anchor manifold 38. The lower aerostat tube array manifold 38 is a circular ring of very light but very strong material that supports the weight of all the tube array and all components attached to it. The lower ends of the lower aerostat tube array 60 are attached to tube array liquid collection channel 26. The channel 26 is a circular channel where all tubes of the lower aerosol tube array 12 terminate. Liquid water drops 60 sliding from the tube surfaces are collected in channel 26 and piped down through channel liquid transport conduit 14 that are connected to main liquid transport conduit 18 to storage reservoir 28 on the ground. The tube array liquid collection channel 26 may be a circular channel with a trapezoidal cross section where all the tubes of the tube array terminate and attached. The wider top of the trapezoid-shaped channel 26 is facing upward so that all the liquid sliding down the tubes 12 surfaces ends up in the channel. The channel 26 empties its collected liquid into the main liquid transport conduit 18. The main liquid transport conduit 18 discharges the liquid it collects from the liquid collection funnel 22 and the tube array liquid collection channel 18 into reservoir 28 which is located on the ground. The main transport conduit 18 as well as conduits 14 may be made of very thin and light but strong material. The conduit 18 and 14 conduits may be of the lay-flat tube type. In another embodiment, these conduits may be made of double skinned tubes where the tube wall is inflated but with a cavity in the middle of the tube to convey liquid. The collection tubes may be inflated with gas that weighs less than air to provide buoyancy.

The energy and aerosol extraction apparatus 10 upper aerostat 60, in one embodiment being a balloon, is contained in upper aerostat 60 restrain net 34. The purpose of the restrain net 34 is containment of aerostat 60 in the desired location in space, while main tether 24 and side tethers 78 serve to anchor aerostat 60 in a general location in the atmosphere but anchored to the ground. The main tether 24 connects the upper aerostat to the tether deploy and retract mechanism 36 which is based in the ground. The deploy and retract mechanism 36 is automatic to retract the energy and aerosol extraction apparatus (10) to the ground in the event it is necessary as a result of adverse weather, sudden loss of buoyancy, or any other safety requirement in addition to regular checkups and maintenance. Side tethers 78 are additional tethers that connect the upper aerostat through restrain net 34 to the ground. Side tethers are employed, in one preferred embodiment, to provide additional safety in the event of failure of the main tether 24 as well as containment of the upper aerostat 60 in a more limited sway.

Side tethers 78 may be anchored at high points in the landscape relative to where main tether 24 is anchored to limit the sway of the aerostat due to wind forces. Such attachment of tethers, in one embodiment, may help upper aerostat 60 point upward and align wind turbine anchored to the upper aerostat to be a preferred alignment to the wind. Main liquid Transport conduit 18 transports all liquid collected from the upper aerosol upper aerostat 32, which may be a balloon, then channeled through liquid collection funnel 22 which discharges its liquid to main transport conduit 18 that is attached to lower aerostat tube array 12 for support. The main conduit 18 collects liquid of tube array liquid collection channel 26 through channel liquid transport conduits 14. All collected liquid is transported by main transport conduit 18 to storage tank 28 which may be made of concrete, steel, plastic, inflatable material, or open reservoir. The ground under upper aerostat 32 and lower aerostat tube array 12 may be covered with an impervious material, such as plastic liner, not shown, to collect liquid blown off the aerostat 32 and 12.

Upper aerostat 32 may be fitted with wind turbine 10, to produce electrical energy. The wind turbine may be fitted on top of upper aerostat 32 using wind turbine base 40 which may be a cap frame made of thin but strong material that is held in place by being braced by the upper aerosol restraint net 34. In another embodiment, another net specially designated to hold in place wind turbine base 34 may be used. Such net may hold more than one turbine where the diameter of the aerostat 32 is large enough and could minimize interference between multitude turbines. The turbine 32, or turbines, of upper aerostat 32 produce electricity in a manner where the turbine or turbines are orientated to capture the wind, irrespective of whether the turbine is of the vertical or horizontal axis type. The turbine 10 include generator 90 to produce electricity and transmit it to the ground through electric cable 84. The electric cable 84 originates from wind turbine generator 90 of the wind turbine 10 and is clipped to the rib of the wind turbine base 40 down to the upper aerostat restraint net, then to where it attaches to the main tether to the ground where it is connected to electric switch 48. Electricity is then used directly or diverted to storage battery 50. Electrify from the turbine generator 90 or the battery 50 is used to supply alarm device 30 and other safety devices. The battery 50 supplies deployment and retrieval device 36 with electricity as well as other devices as needed. A stand by generator, not shown, is provided to automatically turn on and supply electricity where needed for any of the devices of the apparatus 10 in the event electric supply from the turbine or battery is not available.

Apparatus 10 is provided with mooring robes 20 which serve to tie the apparatus to the ground when retrieved to protect it from being blown away by strong winds.

Where liquid collection funnel 22 interferes with a turbine location, the liquid collection funnel 22 upper aerostat net robes may be pushed outward, without compromising the function of the liquid collection funnel, to form a cylindrical net instead of conical, and clear the wind turbine, which may be contained within the net, by placing a ring of a strong but light material in a manner to convert the conically orientated aerostat 32 restraint net robes from conical to cylindrical form.

The upper aerostat is tethered to the ground by at least main tether 24. Additional tethers 78 may be added to provide safety and stability to the FIG. 1 structure. The main tether 24 and side tethers 78 are made from light but strong material to withstand the pull of gusts of wind. Chips may be imbedded in the tethers as well as electric cable to send a signal to the control room and safety attendant if any of them break.

Upper aerostat is equipped with all the pressure equalizing and other features such as manufactured by Aeroballoon company except that it is not used for human lift and is modified to reduce weight of gondola and other components to be able to lift the added components described in this patent application such as lower aerostat tube array, bubble surfaces and other items.

### ALAC Preliminary Economic Feasibility

ALAC is a system of aerostats and wind turbine designed to collect liquid aerosol and generate power. Microdroplets of liquid water are produced in the atmosphere and may not fall as rain. ALAC is a process and apparatus to collect such droplets and transport them to storage on the ground based on the collision and coalescence theory and model. ALAC may also produce power.

Assumptions: Model: An Aerostat of 8 meter-diameter balloon with 140 of 0.3 m diameter and 150-meter-long tube array tethered to the ground. Interest rate of 6%.

Depreciation:

Balloon and tethers: 20 years; Mechanical: 20 years; Civil: 20 Years; Tube Array 10 years

Maintenance:

Balloon: 2%; Mechanical: 10% Civil: 5%; Tube Array: 5% Land rent: No cost Cloud Liquid Water Content (LWC): 2 grams/cubic meter or 2 parts per million (PPM) at 150-meter elevation; Wind Speed 20 Km/hour

Total Aerostat Area Calculation:

Aerostat: One helium-filled Balloon of 8-meter diameter; 140 Cylindrical Tube Array, diameter: 0.30 meter and 150 meter long each; Surface area of balloon: 7×7×4×3.14=615 square meters; Surface area of tube array: each is 0.30 diameter×3.14×140 no. of tubes×150 height of tube=19,780. Surface area of balloon and tube array: 20,395 square meters, say 20,000 square meters. Wind Facing: 10,000 square meters. Contribution of back side may be significant but is not included.

Water Production:

### Water Volume Per Day Passing Aerostat:

20,000 m wind speed×10,000 m² aerostat area×24 hours/day×2 PPM=9,800 Cubic Meter per day. Assume 50 cloudy days/year:
50×9,800=490,000 cubic meter (CM) of water contacting aerostat
Assume 20% efficiency water collection: 98,000 CM. Approximate to 100,000 CM in 50.
Say water collected: 100,000 cubic meter per year of 50 cloudy days
100 units deployed collect 10,000,000 cubic meter of rain quality water per year.

Consider a commercial operation of 100 units:
Capital Cost (CAPEX): USD
Balloon and tethers: 7,500,000 Electro-mechanic: 3,000,000 Civil: 2,000,000
Tube Array: 2,000,000
Power: For a small wind turbine and batteries: 1,000,000
Land (None Depreciable) NO COST

Total Capital Cost: 15,500,000

### Operating Expenses (OPEX):

Manpower: 40,0000 man-hours at $25/hr for 100 units=1,000,000

### Depreciation:

Balloon: 375,000

Electro-mechanical: 150,000

Civil 100,000

Tube array 200,000

Total: 775,000

### Maintenance:

Balloon: 100,000

Mechanical 150,000

Civil 100,000

Tube array 200,000

Total 550,000

Insurance: 200,000

6% interest 1,021,500

Total 1,221,500

TOTAL ANNUAL OPERATING COST: 2,526,500

Water Production:

Production 100 units:
Option 1: 10,000,000 cubic meters per year
Option 2: 20,000,000 Cubic meters per year due to higher wind speed, 100 cloudy days

### Total Revenue (USD):

Option 1: At USD 0.50 per cubic meter 0.50×10,000,000=5,000,000 USD
Option 2: At USD 0.50 per cubic meter 0.50×20,000,000=10,000,000 USD

Power Generation:

100 Wind Turbines each rated at 10 KW Operating for 8000 hours per year:

100×10×8,000=8,000,000 KWH per year

### Price at 0.05 USD/KWH=400,000 USD

Assume that all produced electricity will be donated to the community in exchange for free land rent.
Hydropower potential: Hydropower may be realized but is not considered in the profitability analysis.

Profitability Analysis:

Consider Total Capex to include 25% of annual operating cost to get the project started:

15,500,000+(2,526,000/4)=15,500,000+631,500=16,131,500 USD

### Option 1: ((5,000,000−2,526,000)/16,131,000)×100=15%

### Option 2: ((10,00,000−2,526,000)/16,131,000×100=46%

Financial Analysis Based on Data and Assumptions of ALAC in Text

TABLE 1
NPV and DCFROR of option 1: Revenue 5 million USD
at 20% collection efficiency

| RESULTS | OUTPUT | SENS. OUTPUT |
|---|---|---|
| DCFROR | 17.83% | 17.83% |
| Payout (Years) | 6.59 | 6.59 |
| NPV @ 0% (M$) | 34 | 34 |
| NPV @ 10% (M$) | 7 | 7 |
| NPV @ 5% (M$) | 16 | 16 |

NPV = Net Present Value
DCFROR = Discounted Cash Flow Rate of Return

TABLE 2
NPV and DCFROR of option 2: Revenue of 10 million USD at 40%
collection Efficiency

| RESULTS | OUTPUT | SENS. OUTPUT |
|---|---|---|
| DCFROR | 71.40% | 71.40% |
| Payout (Years) | 2.02 | 2.02 |
| NPV @ 0% (M$) | 147 | 147 |
| NPV @ 10% (M$) | 52 | 52 |
| NPV @ 5% (M$) | 84 | 84 |

NPV = Net Present Value
DCFROR = Discounted Cash Flow Rate of Return

All rights reserved to Glacier Technologies, Inc. 2017

Objectives include:

1. Provision of an apparatus and method to extract aerosol, such as liquid micro-droplets of water in fog and clouds, from a gaseous stream, such as air, comprised of aerostats placed to intercept the pathway of aerosol carrying gas to cause separation of heavier aerosol from lighter gas and coalescence of aerosol into larger drops, due to speed reduction, disturbance and impact; and for the large drops to slide down the aerosol surface due to gravity and be collected and stored for multiple uses, and where the surfaces may be coated with hydrophobic/hydrophilic materials to increase/reduce the liquid drop-aerostat surface adhesion and are designed to extract more aerosol, and where alarm and safety instrumentation warn to retrieve the devise in an emergency or deploy when conditions for operation are adequate.

2. In combination with the apparatus and method to extract aerosol where the apparatus may one or more aerostats, such as inflated tethered balloons, that may be filled with lighter than air gas and made of light but strong durable material such as Mylar, polyester rip-stop, Dacron, nylon, polyurethane coated Tedlar fabric, graphene aerogel and the like.

3. In combination with the apparatus and method to extract aerosol where the aerostat diameter range is about 2 to 50 meters and payload of about 100 to 10,000 kilograms.

4. In combination with the apparatus and method to extract aerosol whose purpose is to rise, subject to wind forces, to a designated height where aerosol content is rich and wind speeds are moderate to high, and intercept aerosol carrying gas to separate aerosol from gas and enable aerosol to coalesce into larger droplets that adhere to the aerostat surface and drain down to storage.

5. In combination with the apparatus and method to extract aerosol where the aerostat rises to a height of about 10 to 50000 meters above the ground, when deployed, where wind speed and high cloud liquid water content (LWC) contribute to higher liquid collection from air.

6. In combination with the apparatus and method to extract aerosol where the aerostat may carry a tube, a sheet, or an array of tubes, sheets and nets suspended from the aerostat and may extend to the ground.

7. In combination with the apparatus and method to extract aerosol where tubes are made of very light and strong material with 5 to 50-centimeter diameter and spatially arranged to form a vertical cylinder of the tubes made up of several tubes with space between each tube and the other to allow passage of air after it lost much of its liquid aerosol content.

8. In combination with the apparatus and method to extract aerosol where tube array made up of one or more tubes and where each tube is connected at its upper terminal point to a circular tube array restraining ring, made of hard strong material, and suspended below aerostats and held in place by robes connected to the aerostat restraint net.

9. In combination with the apparatus and method to extract aerosol where the tube may open to self-inflate if needed to increase surface area of tube and extract more water.

10. In combination with the apparatus and method to extract aerosol where the tube may be inflated with gas preferably with a density less than air.

11. In combination with the apparatus and method to extract aerosol where the tube, sheet or the like are orientated to obstruct the path of aerosol carrying gas to cause the aerosol to separate from gas and adhere to the solid surface and for the gas to escape irrespective of what direction the aerosol carrying gas is blowing from.

12. In combination with the apparatus and method to extract aerosol where the tube, sheet or the like may extend vertically, as may be allowed law and other limitations, to a height from of about 5000 meters.

13. In combination with the apparatus and method to extract aerosol where the tubes may be filled with gas preferably lighter than air in density.

14. In combination with the apparatus and method to extract aerosol where the aerostat surface may be covered with gas filled bubbles to increase the aerostat outer surface area, increase air turbulence, and consequently the amount of aerosol collected from the atmospheric gas.

15. In combination with the apparatus and method to extract aerosol where the bubbles are about 0.25 to 5 cm in diameter.

16. The apparatus of claim 1 In combination with the apparatus and method to extract aerosol 4 where the bubbles are separated from each other by spaces from about half to twice the diameter of the bubbles to freely drain liquid drops downward for collection and storage.

17. In combination with the apparatus and method to extract aerosol where surface of the aerostat is made from or coated with hydrophilic material for top of bubbles to attract liquid aerosol, and hydrophobic depressions between bubbles so liquid drop maintains almost spherical shape due to high surface tension, minimize drop-aerostat surface adhesion and speed up drops roll down the aerostat surface to be collected with minimum evaporation.

18. In combination with the apparatus and method to extract aerosol where center of the aerostat is underlain outside the aerostat by an aerosol collection funnel to collect aerosol collected on surface and draining down the aerostat surface.

19. In combination with the apparatus and method to extract aerosol where the collection funnel is made of very light, strong and durable material of double lining that may be inflated to maintain shape.

20. In combination with the apparatus and method to extract aerosol where the angle of the funnel conical wall is the same as that of the aerostat restraining net when the aerostat is deployed such that the funnel is fits snugly into the net cone and is supported by it.

21. In combination with the apparatus and method to extract aerosol where the funnel top diameter is ½ the diameter of the aerostat of claim 1.

22. The apparatus of claim 18 where the aerosol collection funnel is supported by the aerostat net robes.

23. In combination with the apparatus and method to extract aerosol where the collection funnel lower orifice terminates into a tube to channel liquid collected from the aerostat of claim 1 to the storage tank on the ground.

24. In combination with the apparatus and method to extract aerosol where liquid conveyance tubing network collects liquid from funnel of claim 18 and from lower aerostat tube array liquid collection channel to empty into reservoir on the ground.

25. In combination with the apparatus and method to extract aerosol where the conveyance piping network has a main tubing made of strong, light and durable tubing with a diameter of about 5 to 30 cm which could be made of lay-flat or inflated double wall, filled with lighter than air gas, and with internal conveyance cavity for liquid transport.

26. A lower aerostat liquid collection channel to collect water drops draining from outer surfaces of lower aerostat tube array and drain collected water to main drain through channel liquid transport conduits.

27. An apparatus of cylindrically arranged lower aerostat tubes where aerosol of liquid water passing through vertical vents between the tubes, after some of it's water liquid aerosol has been collected, is collected by the tube back surfaces as atmospheric gas carrying it passing through on its way out.

28. Tether that weighs about 10 to 400 kg.

29. Tether that is 50 to 5000-meter long.

30. An apparatus where the payload of the aerostat is greater than the total weight of all components attached to the aerostat when wet at zero wind speed and any drag forces acting on the aerostat.

31. A land based mechanism to deploy and retrieve the aerostat aerosol-gas separation apparatus.

32. A retrieval mechanism that is operated manually or automatically to deploy apparatus and to respond to set safety parameters.

33. An aerostat tube array containment net of very thin, light but strong twine that forms a lattice structure with its top attached to the lower aerosol anchor manifold and its lower ends attached to the lower aerostat tube array liquid collection channel, extending the length of tubes, a width of a tube, and contains the tubes with one empty space between each two tubes that is one tube diameter in width, and with horizontal circular rings interspersed along its length and made of very light hollow and strong material such as graphene spaced every 20-50 meters along the length and inside of the tube cylindrical arrangement to maintain the tube array in a cylindrical configuration.

34. A cylindrical arrangement of the inflated tube array creates a chimney effect where an upwardly moving draft carrying aerosol produces water drops on the inwardly facing outer surfaces of the tube array within the chimney and contribute to increased production of larger liquid drops that slide to storage.

35. Tubes of the tube array self-inflation option creates drafts inside each of the tubes and increases aerosol upward flow rate and contact with inner surface of tube to produce more aerosol-gas separation, surface contact with aerosol and formation of larger drops that slide to storage to increase production.

36. An impervious lining laid on the ground to collect liquid that may be shed from the aerosol-gas separation apparatus of claim 1 due to strong winds, tilt or the like.

37. A water storage reservoir that may be made of concrete, plastic, metal or any other material that is safe for water storage, preferably built on top of a hill, platform, building or on the ground such as an open reservoir such as a lake.

38. At least one wind turbine anchored to the aerostat to generate electric power.

39. Wind turbine where, in one embodiment, one turbine may be positioned on the top half of the claim 2 aerostats and another one at the bottom half, in a mirror image of the top turbine.

40. Wind turbine(s) where rotor axis of the turbine(s) is vertical rotating shaft around a fixed hard anchor element that is bolted to the top center and another wind turbine bolted to the bottom center of aerostat.

41. Wind turbine where blade lower edge curve clears the outer surface of aerostat.

42. Wind turbine where blades are made of very thin, light and strong material and may be supported by braces.

43. Wind turbine where the electric generator is cleared from the rotor with a cut out in the blades to clear the generator housing and allow free blade rotation.

44. A wind turbine where turbine has at least one blade.

45. Wind turbine where blades are shaped in the form of a cylindrical arc with its lower base shaped to clear the curved outer surface of the aerostat and its top and sides may take many forms.

46. Wind turbine where the blades are made of very light but very strong material such as graphene aerogel.

47. Wind turbine where turbine blades extend axially commensurate with the size of the aerostat of claim 2 and as small as one meter and as much as 10 meters long.

48. Wind turbine where the features of a vertical axis turbines may be incorporated.

49. A wind turbine where at least one horizontal circular rail track may be bolted to the aerostat outer surface between the top apex of the aerostat and the lower terminal end of the blade to serve as an extra support for the rotor where the wheels bolted to the lower base of the blades allow the blades to travel over the rail.

50. A heat exchange efficient shroud to contain condensing vapor generated by processes, such as cooling towers, and channel it toward apparatus for recovery of water and power.

51. use of the apparatus aerostat of claim 1 for other applications such as telecommunication, photography, surveillance, mapping, observations or other applications.

52. A hydropower turbine to generate power using the potential energy of water at higher elevation either from vertical rigid pipe of flowing water from device and or from an elevated water reservoir located at higher elevation than the point of use.

53. An economic feasibility and financial analysis that shows, at 20% efficiency, positive Net Present Value and Discounted Cash Flow Rate of Return is an objective.

What is claimed is:

1. An apparatus and method to extract aerosol, such as liquid micro-droplets of water in fog and clouds, from a gaseous stream, such as air, comprised of aerostats placed to intercept the pathway of aerosol carrying gas to cause separation of heavier aerosol from lighter gas and coalescence of aerosol into larger drops, due to speed reduction, disturbance and impact; and for the large drops to slide down the aerosol surface due to gravity and be collected and stored for multiple uses, and where the surfaces may be coated with hydrophobic/hydrophilic materials to increase/reduce the liquid drop-aerostat surface adhesion and are designed to extract more aerosol, and where alarm and safety instrumentation warn to retrieve the devise in an emergency or deploy when conditions for operation are adequate.

2. The apparatus of claim 1 where the apparatus may one or more aerostats, such as inflated tethered balloons, that may be filled with lighter than air gas and made of light but strong durable material such as Mylar, polyester rip-stop, Dacron, nylon, polyurethane coated Tedlar fabric, graphene aerogel and the like.

3. The apparatus of claim 2 where the aerostat diameter range is about 2 to 50 meters and payload of about 100 to 10,000 kilograms.

4. The apparatus of claim 1 whose purpose is to rise, subject to wind forces, to a designated height where aerosol content is rich and wind speeds are moderate to high, and intercept aerosol carrying gas to separate aerosol from gas and enable aerosol to coalesce into larger droplets that adhere to the aerostat surface and drain down to storage.

5. The apparatus of claim 1 where the aerostat rises to a height of about 10 to 50000 meters above the ground, when deployed, where wind speed and high cloud liquid water content (LWC) contribute to higher liquid collection from air.

6. The apparatus of claim 1 where the aerostat may carry at least one of a tube, a sheet, or an array of tubes, sheets and nets suspended from the aerostat and may extend to the ground.

7. The tubes of claim 6 where tubes are made of very light and strong material with 5 to 50-centimeter diameter and spatially arranged to form a vertical cylinder of the tubes made up of several tubes with space between each tube and the other to allow passage of air after it lost much of its liquid aerosol content.

8. Tubes of claim 7 where tube array made up of one or more tubes and where each tube is connected at its upper terminal point to a circular tube array restraining ring, made of hard strong material, and suspended below the aerostats and held in place by robes connected to the aerostat restraint net.

9. The apparatus of claim 6 where the tube may open to self-inflate if needed to increase surface area of tube and extract more water.

10. The apparatus of claim 6 where the tube may be inflated with gas preferably with a density less than air.

11. The apparatus of claim 6 where the tube, sheet or the like are orientated to obstruct the path of aerosol carrying gas to cause the aerosol to separate from gas and adhere to the solid surface and for the gas to escape irrespective of what direction the aerosol carrying gas is blowing from.

12. The apparatus of claim 6 where the tube, sheet or the like may extend vertically, as may be allowed law and other limitations, to a height from of about 5000 meters.

13. The apparatus of claim 6 where the tubes may be filled with gas preferably lighter than air in density.

14. The apparatus of claim 1 where the aerostat surface may be covered with gas filled bubbles to increase the aerostat outer surface area, increase air turbulence, and consequently the amount of aerosol collected from the atmospheric gas.

15. The apparatus of claim 14 where the bubbles are separated from each other by spaces from about half to twice the diameter of the bubbles to freely drain liquid drops downward for collection and storage.

16. The apparatus of claim 14 where surface of the aerostat is made from or coated with hydrophilic material for top of bubbles to attract liquid aerosol, and hydrophobic depressions between bubbles so liquid drop maintains almost spherical shape due to high surface tension, minimize drop-aerostat surface adhesion and speed up drops roll down the aerostat surface to be collected with minimum evaporation.

17. The apparatus of claim 1 where center of the aerostat is underlain outside the aerostat by an aerosol collection funnel to collect aerosol collected on surface and draining down the aerostat surface.

18. A lower aerostat liquid collection channel for collecting water drops draining from outer surfaces of lower aerostat tube array and drain collected water to main drain through channel liquid transport conduits.

19. An apparatus of cylindrically arranged lower aerostat tubes where aerosol of liquid water passes through a vertical vent between the tubes, upon collection of water liquid aerosol is collected by the tube back surfaces as atmospheric gas carrying it passing through on its way out.
